(19) United States
(12) Patent Application Publication
(10) Pub. No.: US 2026/0002507 A1
(43) Pub. Date: Jan. 1, 2026

(54) HYDRAULIC TURBINE

(71) Applicant: Natel Energy Holdings, Inc., Alameda, CA (US)

(72) Inventors: Abraham D. SCHNEIDER, San Francisco, CA (US); Sterling Marina WATSON, San Francisco, CA (US)

(21) Appl. No.: 19/099,701

(22) PCT Filed: Aug. 30, 2024
(86) PCT No.: PCT/US2024/044912

§ 371 Date: Jan. 29, 2025

Related U.S. Application Data
(60) Provisional application No. 63/536,266, filed on Sep. 1, 2023.

(51) Int. Cl. F03B 3/12; F03B 3/06

(52) U.S. Cl. CPC F03B 3/123; F03B 3/06; F05B 2220/32; F05B 2240/303; F05B 2240/307

(57) ABSTRACT

A runner for a hydraulic turbine, including a hub and a plurality of pivotable blades extending from the hub. Each pivotable blade of the plurality of pivotable blades includes a root located at the hub, a tip opposite the root, and a leading edge. Each pivotable blade of the plurality of pivotable blades is pivotable relative to the hub about a respective pivot axis. For at least one blade, the leading edge at the root is positioned along a radial axis of the runner and the leading edge at the tip is cantilevered beyond the radial axis in a circumferential direction of the runner.

### CROSS-REFERENCE TO RELATED APPLICATIONS

The present applications claims priority to U.S. Provisional Application No. 63/536,266, filed Sep. 1, 2023, which is incorporated herein by reference in its entirety.

### FIELD OF THE INVENTION

The present invention relates to a hydroelectric turbine runner. Specifically, the present invention relates to a turbine runner configured to promote safe downstream passage of fish or other aquatic organisms through the turbine, while achieving high efficiency across a wide operating range.

### BACKGROUND OF THE INVENTION

There is an increasing need for hydropower plants that have a low impact on the environment. In order to reduce environmental impact, it is desirable for hydropower plants to have a minimal effect on fish and other aquatic organisms (e.g., by not harming aquatic organisms and by avoiding blocking the travel or migration of aquatic organisms). It is also desirable to construct hydropower plants that have high efficiency and relatively low installation, operation, and maintenance costs. It is also sometimes desirable to retrofit existing hydropower plants with new turbines for reduced environmental impact and/or improved efficiency.

Accordingly, there is a continuing need in the art for a turbine that allows for safe downstream passage of fish and other aquatic organisms through the turbine and that has high efficiency, that has relatively low installation, operation, and maintenance costs, and that can be used in a wide range of applications, including retrofit installations.

### BRIEF SUMMARY OF THE INVENTION

A runner for a hydraulic turbine can include a hub and a plurality of pivotable blades extending from the hub. Each pivotable blade of the plurality of pivotable blades can include a root located at the hub, a tip opposite the root, and a leading edge. Each pivotable blade of the plurality of pivotable blades can be pivotable relative to the hub about a respective pivot axis. A ratio of a thickness of the leading edge T_{LE} to a diameter of the runner D_{R} can be in a range of approximately 0.03 to approximately 0.35. For at least one blade, the leading edge at the root can be positioned along a radial axis of the runner and the leading edge at the tip can be cantilevered beyond the radial axis in a circumferential direction of the runner. The runner can include a ratio of the runner axial length to the diameter of the runner that is less than 0.55. The runner can include a ratio of a chord length at the tip of each pivotable blade to the diameter of the runner that is less than 0.9. The runner can be configured such that each pivot axis is angled relative to the shaft axis of the runner at an angle between approximately 8 degrees and approximately 155 degrees. The runner can be configured such that each pivot axis is angled relative to the shaft axis of the runner at an angle between approximately 30 degrees and approximately 100 degrees. The runner can be configured such that each pivot axis is angled relative to the shaft axis of the runner at an angle of approximately 90 degrees. An outer surface of the hub can be swept by the root of each pivotable blade during rotation of the blade from a maximum pitch to a minimum pitch and can be spherically shaped. The root of each pivotable blade can conform to the shape of the outer surface of the hub during rotation of the blade from a maximum pitch to a minimum pitch. The tip of each pivotable blade can have a generally spherical sweep shape over a pivot range of the blade from a maximum pitch to a minimum pitch. A thickness of the leading edge of each pivotable blade can be between about 100 mm and about 700 mm. A portion of the leading edge at the tip of each pivotable blade can be slanted relative to a radial axis of the runner at an angle between approximately 20 degrees and approximately 90 degrees. A portion of the leading edge at the tip of each pivotable blade can be slanted relative to a radial axis of the runner at an angle between approximately 25 degrees and approximately 45 degrees. The leading edge of each pivotable blade can be arc-shaped when viewed along an axis that is perpendicular to a shaft axis of the runner. The leading edge of each pivotable blade when viewed along an axis that is perpendicular to a shaft axis of the runner can curve away from an upstream end of the runner at the root and then back toward an upstream end of runner toward the tip. A radius of curvature of the one or more faces can be larger than a radius of curvature of the rounded edges of the hub. A first portion of the trailing edge can be concave, a second portion of the trailing edge can be convex, and the first portion of the trailing edge can be located closer to the hub than the second portion of the trailing edge. A ratio of chord length at the tip of each pivotable blade to chord length at the root of each pivotable blade can be approximately 1.6 to approximately 2.5.

The runner can be utilized in a turbine, the runner being positioned within a housing defining an inlet and an outlet for a flow of liquid. The tip of each pivotable blade can conform to a shape of a discharge ring of the housing during rotation of the blade from a maximum pitch to a minimum pitch. An inner surface of a discharge ring of the housing swept by the tip of each pivotable blade during rotation of the blade from a maximum pitch to a minimum pitch can be spherically shaped. A discharge ring of the housing can have removable segments which are removably assembled from either an exterior or from an interior of the turbine. A discharge ring of the housing can be split axially. A discharge ring of the housing can be split radially. The turbine can include a generator operably coupled to the runner, such as a fixed-speed generator or a variable-speed generator.

Some embodiments described herein relate to a runner for a hydraulic turbine, can include a hub and a plurality of pivotable blades extending from the hub. Each pivotable blade of the plurality of pivotable blades can include a root located at the hub, a tip opposite the root, and a leading edge opposite a trailing edge. Each pivotable blade of the plurality of pivotable blades can be pivotable relative to the hub about a respective pivot axis. For at least one blade, the leading edge at the root can be positioned along a radial axis of the runner and the leading edge at the tip can be cantilevered beyond the radial axis in a circumferential direction of the runner. A ratio of a thickness of the leading edge T_{LE} to a diameter of the runner D_{R} is in a range of approximately 0.03 to approximately 0.35. A leading edge thickness can be greater than a trailing edge thickness. In a meridional section, the trailing edge at the root of the blade can be located further downstream than the trailing edge at the tip of the blade.

In any of the various embodiments described herein, the trailing edge can extend rearward of a downstream end of the hub for at least one pivotable blade of the plurality of pivotable blades. In some examples, at least one pivotable blade of the plurality of pivotable blades has a cross section at the root with a surface curvature having a first shape and a second shape, wherein the first shape is concave and the second shape is convex.

In any of the various embodiments described herein, the hub can include a plurality of faces that can be planar, the faces being radially spaced around a longitudinal axis of the hub. In some embodiments, the trailing edge of a pivotable blade of the plurality of pivotable blades can bow in an upstream direction between the tip and root of the pivotable blade.

### BRIEF DESCRIPTION OF THE DRAWINGS/FIGURES

The accompanying drawings, which are incorporated herein and form a part of the specification, illustrate the present disclosure and, together with the description, further serve to explain the principles thereof and to enable a person skilled in the pertinent art to make and use the same.

FIG. 1 is a perspective view of a runner for a hydraulic turbine according to an embodiment.

FIG. 2 is another perspective view of the runner according to FIG. 1.

FIG. 3 is another perspective view of the runner according to FIG. 1.

FIG. 4 is an upstream view of the runner according to FIG. 1.

FIG. 5 is a downstream view of the runner according to FIG. 1.

FIG. 6 is a side view of the runner according to FIG. 1.

FIG. 7 is another side view of the runner according to FIG. 1.

FIG. 8 is another side view of the runner according to FIG. 1.

FIG. 9 is another side view of the runner according to FIG. 1.

FIG. 10 is a cross sectional view of the runner according to FIG. 1 taken at line X-X′ of FIG. 6.

FIG. 11 is another side view of the runner according to FIG. 1, with the blades adjusted to an angle of 5 degrees.

FIG. 12 is another side view of the runner according to FIG. 1, with the blades adjusted to an angle of 10 degrees.

FIG. 13 is another side view of the runner according to FIG. 1, with the blades adjusted to an angle of 17 degrees.

FIG. 14 shows the runner of FIG. 1 installed in a hydraulic turbine according to an embodiment, with the blades adjusted to an angle of 5 degrees.

FIG. 15 shows the runner of FIG. 1 installed in a hydraulic turbine according to an embodiment, with the blades adjusted to an angle of 10 degrees.

FIG. 16 shows the runner of FIG. 1 installed in a hydraulic turbine according to an embodiment, with the blades adjusted to an angle of 17 degrees.

FIG. 17 shows a runner installed in a hydraulic turbine according to an embodiment.

FIG. 18 shows a runner for a hydraulic turbine according to an embodiment.

FIG. 19 shows a runner for a hydraulic turbine according to an embodiment.

FIG. 20 is a partial sectional view of a runner for a hydraulic turbine according to an embodiment.

FIG. 21 shows top-down view of a runner for a hydraulic turbine according to an embodiment.

FIG. 22 shows a perspective view of a runner for a hydraulic turbine according to an embodiment.

FIG. 22A shows a perspective view of a runner for a hydraulic turbine according to an embodiment, with a split surface discharge ring.

FIG. 23 shows a side view of a runner for a hydraulic turbine according to an embodiment, with blades adjusted towards a closed position.

FIG. 24 shows a side view of a runner for a hydraulic turbine according to an embodiment, with blades adjusted towards an open position.

FIG. 25A shows a side view of a runner for a hydraulic turbine according to an embodiment, with blades adjusted towards an open position.

FIG. 25B shows cross-sections of a blade of FIG. 25A taken at the root, midspan and tip of the blade.

FIG. 26 shows a rear perspective view of a runner for a hydraulic turbine according to an embodiment, with blades adjusted towards a closed position.

FIG. 27 shows a perspective view of a runner for a hydraulic turbine according to an embodiment.

FIG. 28 shows a graph comparing normalized chord distribution of conventional blades and a blade for the present disclosure.

### DETAILED DESCRIPTION OF THE INVENTION

In the following description, numerous specific details are set forth in order to provide a thorough understanding of the embodiments of the present disclosure. However, it will be apparent to those skilled in the art that the embodiments, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring aspects of the disclosure.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

As used herein, the terms “about” or “approximately” may refer to the stated amount or value +/−5%.

The following examples are illustrative, but not limiting, of the present disclosure. Other suitable modifications and adaptations of the variety of conditions and parameters normally encountered in the field, and which would be apparent to those skilled in the art, are within the spirit and scope of the disclosure.

Modern hydropower facilities often must satisfy rigorous criteria for environmental sustainability. Hydropower plants operating at a head of about 60 meters or less often disturb natural ecosystems, particularly by disrupting upstream and downstream movements of fish and other aquatic organisms. However, hydropower development in this range is still desirable due to the relative availability of such installation sites. Medium-head applications (e.g., head greater than 30 meters) are particularly desirable due to the relatively greater power density at these sites as compared to lower-head sites.

Some embodiments described herein provide a runner for a hydraulic turbine for various size applications, including high-head, medium-head, and low-head applications. Some embodiments include runners for use in low-head to medium-head applications (for example, ranging from approximately 3 meters of head to approximately 40 meters of head) which allows for safe downstream passage of fish through a turbine incorporating the runner. Some embodiments described herein also achieve high efficiency and have relatively low installation, operation, and maintenance costs. Some embodiments described herein also achieve high efficiency over a wide range of flow. Some embodiments described herein can be used in a wide range of applications, including retrofit, rehabilitation, modernization, and upgrade installations.

In some embodiments, the runner has adjustable pitch blades. This can, for example, assist in achieving high efficiency over a wide range of flow.

In some embodiments, the pivot axes of the blades are angled relative to a shaft axis of the runner. An angled pivot axis can, for example, allow for adjustable pitch blades while also allowing for the blade features described below (for example, a thick leading edge or a cantilevered leading edge). An angled pivot axis can also allow for substantially diagonal flow through the runner blades, such as is found in a Deriaz turbine. In some embodiments, the pivot axes of the blades is selected to minimize the size of the turbine required to accommodate the blade pivot range of motion. In an aspect, the blade pivot axis can be perpendicular to the shaft axis.

In some embodiments, a blade of the runner has a thick leading edge relative to the size of fish allowed to pass through the turbine. Fish survival after a blade strike event is sensitive to the ratio of fish body length to the thickness of the turbine blade leading edge and speed. For example, blades with a fish length to blade thickness ratio <1 can allow for a fish survival rate of approximately 100% following a blade strike at a strike speed of 7 m/s and >approximately 90% at strike speed of 12 m/s. As a result, a fish that encounters a blade having a thick leading edge is more likely to survive a blade impact relative to a fish that encounters a blade having a thinner leading edge.

In some embodiments, a leading edge of a blade of the runner is arc-shaped when viewed along a shaft axis of the runner. As a result, the orthogonal component w_{N}−w*sin(α) of the strike velocity is reduced, thereby reducing fish mortality from an impact with the blade.

In some embodiments, a leading edge of a blade of the runner is arc-shaped when viewed along an axis that is perpendicular to the shaft axis of the runner (i.e., from a side of the runner).

In some embodiments, a leading edge of a blade of the runner is twisted. Such a shape can allow minimization of the cantilever required by the tip of the leading edge while still achieving the maximum possible integrated fish survival all along the leading edge, by minimizing WN the orthogonal component of strike probability all along the leading edge.

In some embodiments, the runner is incorporated into a turbine.

In some embodiments, the runner is a Kaplan-type turbine runner. In some embodiments, the runner is a Deriaz-type turbine runner.

These and other embodiments are discussed below in more detail with reference to the figures.

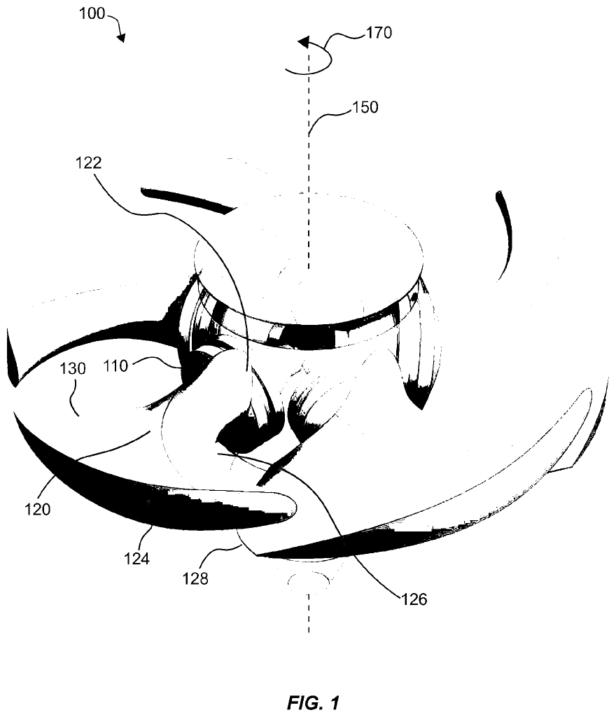

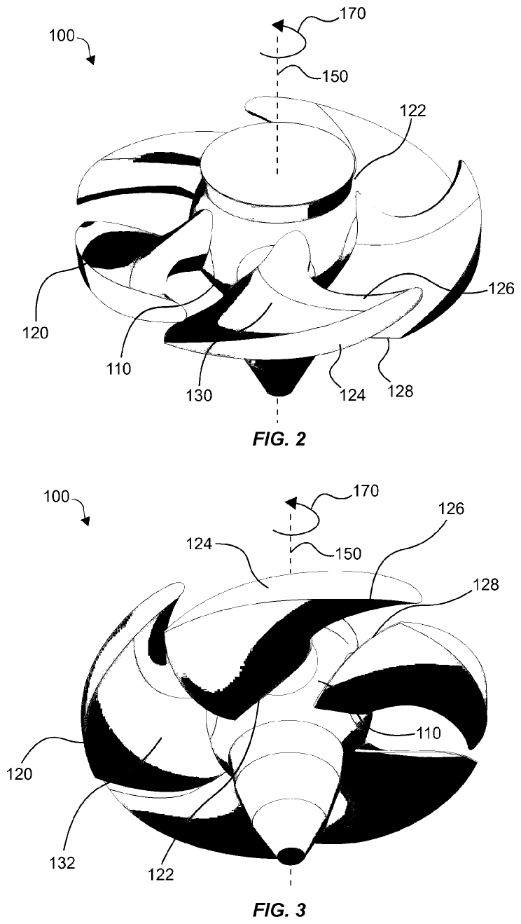

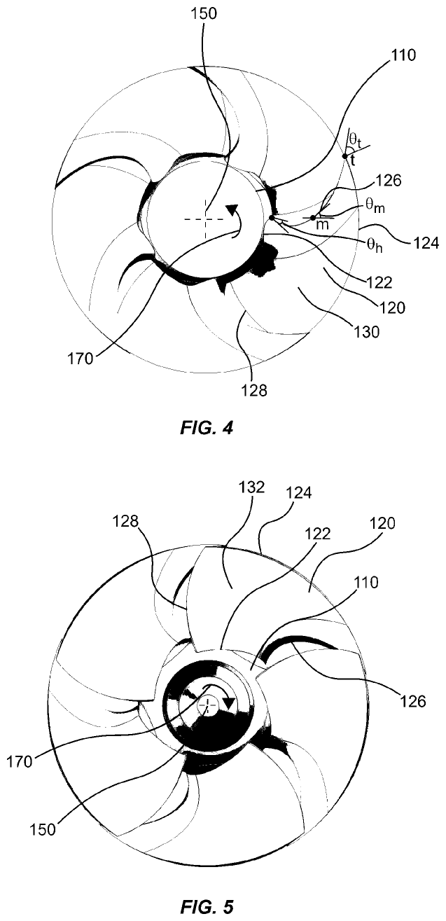

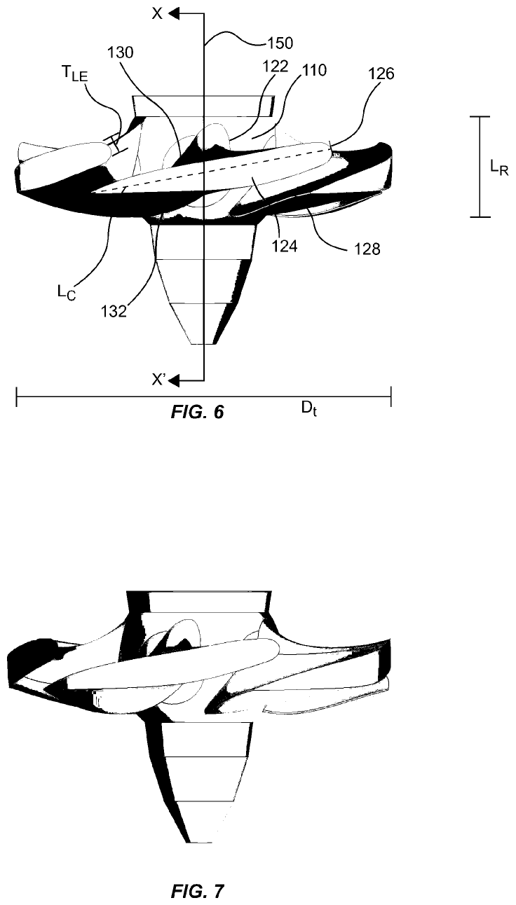

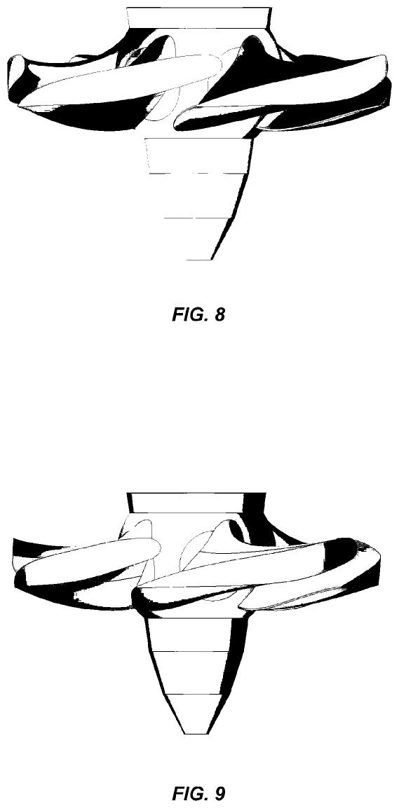

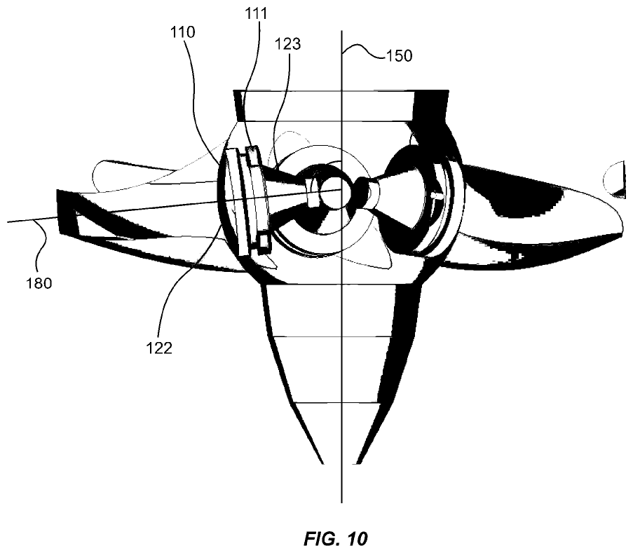

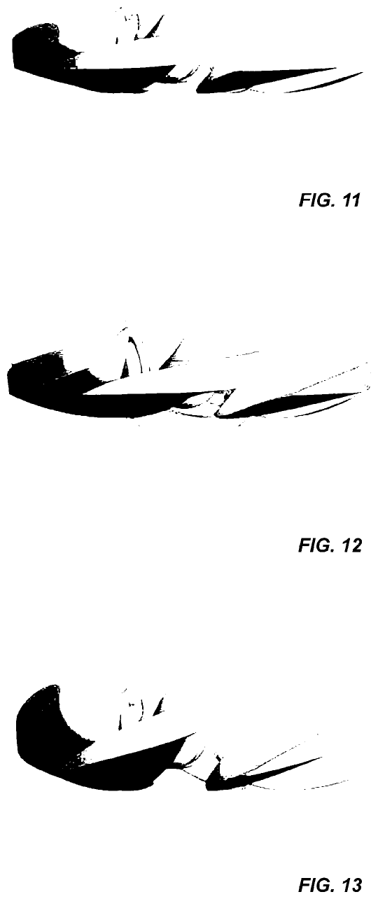

FIGS. 1-13 show a runner 100 according to some embodiments. FIG. 1 shows a perspective view of runner 100, FIG. 2 shows another perspective view of runner 100, FIG. 3 shows another perspective view of runner 100, FIG. 4 shows an upstream view of runner 100, FIG. 5 shows a downstream view of runner 100, FIG. 6 shows a side view of runner 100, FIG. 7 shows another side view of runner 100, FIG. 8 shows another side view of runner 100, FIG. 9 shows another side view of runner 100, FIG. 10 shows a cross sectional view of runner 100 taken at line X-X′ of FIG. 6, FIG. 11 shows another side view of runner 100 with the blades adjusted to an angle of 5 degrees, FIG. 12 shows another side view of runner 100 with the blades adjusted to an angle of 10 degrees, FIG. 13 shows another side view of runner 100 with the blades adjusted to an angle of 17 degrees.

Runner 100 can be configured to rotate in a circumferential direction 170 about shaft axis 150 during use in order to drive a load, such as a generator, which may be a generator with a fixed-speed shaft. In the embodiment shown in FIG. 4, for example, circumferential direction 170 is counterclockwise when viewed from an upstream side of runner 100. However, in other embodiments, circumferential direction 170 can be clockwise when viewed from an upstream side of runner 100.

Runner 100 can include a hub 110 and a plurality of blades 120 extending from hub 110. In some embodiments, blades 120 are evenly spaced about a circumference of hub 110. In some embodiments, blades 120 are arranged helically on hub 110.

In some embodiments, each of the plurality of blades 120 of runner 100 has the same shape and dimensions.

In the embodiment illustrated in FIG. 1, runner 100 includes five blades 120. However, in other embodiments, runner 100 can include two blades, three blades, four blades, or more than five blades.

Each blade 120 of runner 100 can include a root 122 located at hub 110, a tip 124 opposite root 122 and defining an outermost extent of blade 120, a leading edge 126 at an upstream portion of runner 100, a trailing edge 128 at a downstream portion of runner 100, a pressure surface 130 on an upstream side of blade 120, and a suction surface 132 on a downstream side of blade 120.

In some embodiments, blades 120 are adjustable pitch blades. This can, for example, assist in achieving high efficiency over a wide range of flow (for example, where runner 100 drives a generator with a fixed-speed shaft). In some such embodiments, as shown, for example, in FIG. 10, blades 120 of runner 100 include pivot ends 123 pivotably coupled to blade links 111 of hub 110 within hub 110. The couplings between pivot ends 123 and blade links 111 can allow blades 120 of runner 100 to be pivoted relative to hub 110 about respective pivot axes 180. In some embodiments, a control system of runner 100 can control the pivot of blades 120 relative to hub 110 by pivoting pivot ends 123 and/or blade links 111.

In some embodiments, blades 120 can be pivoted over a pivot range starting from 0 degrees at fully-open conditions, spanning from a blade angle of 5 degrees to a blade angle of 25 degrees. For example, as shown in FIGS. 11-13, blades 120 can be pivoted to an angle of 5 degrees (FIG. 11), to an angle of 10 degrees (FIG. 12), or to angle of 17 degrees (FIG. 13) to achieve high efficiency over a range of flow. In some embodiments 120 can be pivoted over a pivot range of approximately 15 degrees. In some embodiments 120 can be pivoted over a pivot range of approximately 20 degrees. In some embodiments 120 can be pivoted over a pivot range of approximately 25 degrees.

In some embodiments, blades 120 can be pivoted to close the runner and inhibit passage of water through the runner.

In some embodiments, pivot axis 180 of blade 120 is angled relative to shaft axis 150 of runner 100. Pivot axis 180 may be perpendicular to shaft axis 150, or may be non-perpendicular thereto. For example, pivot axis 180 of blade 120 can be angled relative to shaft axis 150 of runner 100 at an angle β greater than 90 degrees such that pivot axis 180 of blade 120 is angled downstream. In FIG. 10, for example, pivot axis 180 is angled relative to shaft axis at an angle of approximately 97 degrees. In other embodiments, pivot axis 180 can be angled relative to shaft axis at an angle of approximately 8 degrees to approximately 45 degrees.

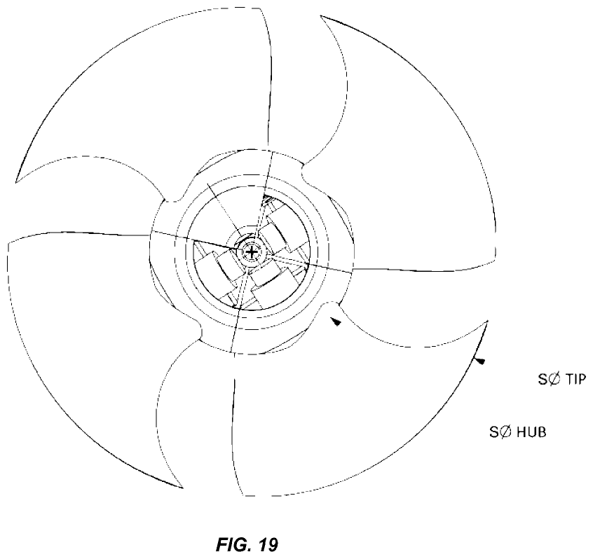

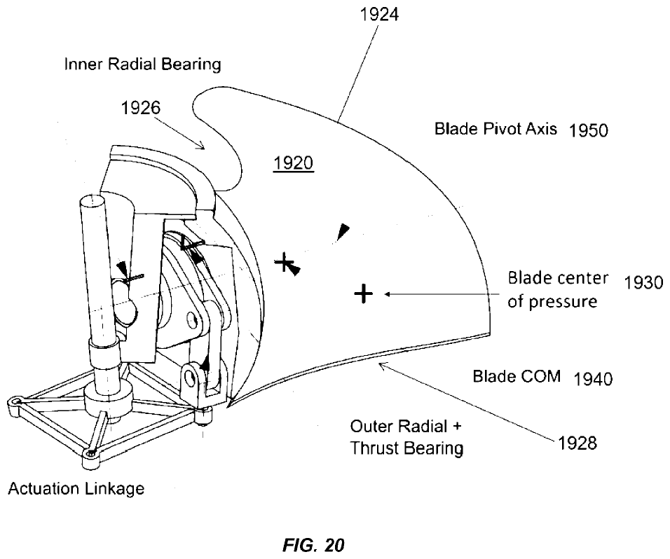

The position of the center of pressure and the position of the blade center of mass (see e.g., FIGS. 19-20), with respect to the blade pivot axis 180 strongly affects mechanical loads of the blade pivot actuation system, as well as the operational behavior of the turbine. In general, it is necessary to choose whether the pivotable turbine blades will exhibit self-closing, or self-opening behavior. The decision to choose self-closing or self-opening needs to include a variety of considerations, and both options can be commonly found in practice. For example, it might be preferable to choose a self-opening design to limit the maximum runaway speed to protect associated equipment, such as the electrical generator. On the other hand, self-closing behavior may be beneficial to make blade adjustment easier during load following. At the maximum power output condition, the center of pressure may be located radially near the midspan of the blade and closer to the trailing edge than to the leading edge, such as approximately 60-80 percent of the midspan chord length. Typically, the blade pivot axis will be located approximately 20-30 percent of the midspan chord. Therefore the hydraulic pressure distribution will tend to create a closing moment about the blade pivot axis. The position of the blade center of mass can be chosen, taking into consideration the hydraulic loads as well as the allowable stresses and available space for the actuation system components. In general, if the blade center of mass is positioned downstream of the blade pivot, the blades will exhibit self-closing behavior when the runner is in rotation about the shaft axis. In contrast, if the blade center of mass is positioned upstream of the blade pivot, the blades will exhibit self-opening behavior. Positioning of the blade center of mass close to the blade pivot axis will tend to reduce the magnitude of inertial moments. The position of the blade center of mass can be determined both by the thickness distribution and positioning of the blade geometry, as well as the distribution of mass within the blade. For example, a hollow blade can be constructed with varying wall thickness to help position the blade center of mass in a desired location with respect to the blade pivot axis.

In some embodiments, the blade pivot axis can be perpendicular to the shaft axis. This configuration may allow for simplification of the actuation system compared to an embodiment utilizing blade pivot axes that are not perpendicular to the shaft axis. For example, the blade pitch angle adjustment system utilizes a set of mechanical linkages, as shown in FIG. 20, spherical joints may be utilized if the blade pivot axes are not perpendicular to the shaft axis. But if the blade pivot axes are perpendicular to the shaft axis, then cylindrical bushings or bearings can be utilized.

As shown, for example, in FIGS. 1 and 10, the shape of root 122 of each pivotable blade 120 can conform to the shape of an outer surface of hub 110 during rotation of blade 120 from a maximum pitch of blade 120 to a minimum pitch of blade 120. For example, in some embodiments, an outer surface of hub 110 swept by root 122 from a maximum pitch of blade 120 to a minimum pitch of blade 120 is spherically shaped, and root 122 at hub 110 can have a generally spherical sweep shape over a pivot range of blade 120 from a maximum pitch of blade 120 to a minimum pitch of blade 120. This can, for example, reduce gaps between hub 110 and root 122 over a pivot range of blades 120 from a maximum pitch of blades 120 to a minimum pitch of blades 120. Gaps between hub 110 and roots 122 can be dangerous for fish because fish can become trapped in a gap and then severed or otherwise wounded. Gaps can also cause losses in hydraulic efficiency as well as localized regions of turbulent flow, high velocities and associated fluid shear forces, and potentially cavitation.

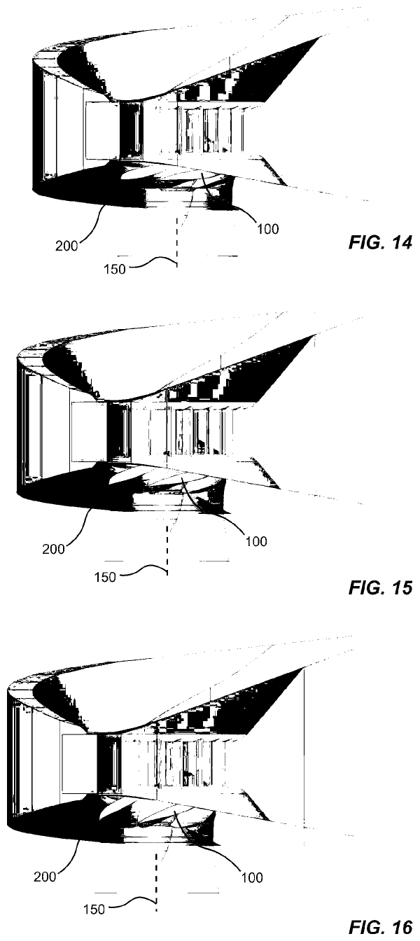

In some embodiments, runner 100 is integrated into a turbine 200 (shown, for example, in FIGS. 14-16). In some embodiments, the shape of tip 124 of each pivotable blade 120 can conform to the shape of an inner surface of turbine 200 housing during rotation of blade 120 from a maximum pitch of blade 120 to a minimum pitch of blade 120. For example, in some embodiments, an inner surface of turbine 200 housing swept by tip 124 from a maximum pitch of blade 120 to a minimum pitch of blade 120 is spherically shaped, and tip 124 can have a generally spherical sweep shape over a pivot range of blade 120 from a maximum pitch of blade 120 to a minimum pitch of blade 120. This can, for example, reduce gaps between blade tips 124 and turbine 200 housing over the pivot range of blades 120 from a maximum pitch of blade 120 to a minimum pitch of blade 120. Gaps between blade tips 124 and turbine 200 housing can be dangerous for fish because fish can become trapped in a gap and then severed or otherwise wounded. Gaps can also cause losses in hydraulic efficiency as well as localized regions of turbulent flow and potentially cavitation.

In some embodiments, the ratio of the diameter of the spherical hub D_{sph_h} to the runner diameter D_{R} is approximately 0.4 to 0.5, such as approximately 0.42 to 0.45.

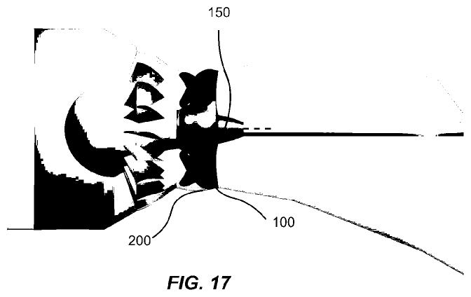

In the embodiment illustrated in FIGS. 10-16, gaps are reduced at hub 110 (due to the generally spherical shape of hub 110 at roots 122 and the generally spherical sweep shape of roots 122 at hub 110) and gaps are reduced at blade tips 124 (due to the generally spherical sweep shape of blade tips 124 over the pivot range of blades 120 and the generally spherical shape of turbine 200 housing at blade tips 124). However, in some embodiments gaps are reduced at hub 110 but not at blade tips 124. For example, in some embodiments, trailing edge 128 can overhang (i.e., extend past the spherical portion of turbine 200 housing as shown in FIG. 17) such that gaps are not minimized at blade tips 124. This can, for example, allow greater flow through turbine 100 while maximizing blade surface area to decrease risk of cavitation (as compared to a runner without a trailing edge overhang). In some examples, leading edge 126 does not overhang or extend upstream of the discharge ring of the turbine housing and may be parallel to or below upstream end of the discharge ring. This is because an overhang at a leading edge may increase a risk of injury to fish entering the turbine runner. However, in some embodiments, leading edge of runner may overhang, or extend upstream of the discharge ring of the housing. This may occur when a runner having a spherical geometry is arranged in a turbine housing having a cylindrical shape, which may provide improved fish safety relative to a conventional turbine runner.

In some embodiments, turbine 200 housing includes a discharge ring (e.g., a spherical discharge ring). In some embodiments, the discharge ring has removable segments which are removably assembled from either an exterior or from an interior of the turbine. In some embodiments, the discharge ring is split axially (e.g., for removal along shaft axis 150). In some embodiments, the discharge ring is split radially (e.g., for removal perpendicular to shaft axis 150).

As shown, for example, in FIG. 6, blade 120 can have a thick leading edge 126 with a thickness T_{LE}.

In some embodiments, leading edge thickness T_{LE} of blade 120 can be at least approximately 50 mm. In some embodiments, leading edge thickness T_{LE} of blade 120 can be the same as or greater than a length of a fish species of interest in the region in which a turbine including runner 100 is to be installed. For example, salmon smolt have a length that is an average of about 100 to 200 mm. Accordingly, the leading edge thickness T_{LE} of blade 120 intended to be used in a region with salmon smolt can be 100 mm to 200 mm or more. Leading edge thicknesses intended to be used in a region with adult migrating eel may need to be 75 mm to 200 mm or more, and it can be important to avoid gaps, such as at the leading edge and hub or leading edge and discharge ring, which can trap and sever an elongate fish like eel. In some examples, the thickness of the leading edge may be between about 100 mm and about 700 mm.

In some embodiments, the ratio of leading edge thickness T_{LE} to runner diameter D_{R} (i.e., T_{LE}/D_{R}) can be approximately 0.03 to approximately 0.35, such as approximately 0.06 to approximately 0.25, such as approximately 0.08 to approximately 0.14.

In some embodiments, the thickness of blade 120 can taper from leading edge 126 toward trailing edge 128. Thickness of blade 120 can be tapered such that pressure surface 130 and suction surface 132 intersect at a point at trailing edge 128 of blade 120.

In some embodiments, blade 120 can have a consistent thickness from root 122 to tip 124. In other embodiments, the thickness of blade 120 can be variable. In some embodiments, the thickness of blade 120 can be greater at tip 124 of blade 120 than at hub 110. The tangential velocity of blade 120 increases from root 122 to tip 124. As a result, the orthogonal component of strike velocity of blade 120 encountering a fish near tip 124 may be greater than the orthogonal component of strike velocity of blade 120 encountering a fish near root 122. To reduce risk of mortality in regions where fish 300 are most likely to experience high strike velocities, the blade can have a thick leading edge and additionally or alternatively a slanted leading edge, as will be discussed.

As shown, for example, in FIG. 4, blade 120 of runner 100 can have a leading edge 126 that is slanted at an angle θ at one or more locations (e.g., locations t, m, h) along leading edge 126. (A curve can be drawn along the apex of the stagnation region of the blade from hub to tip, defining the leading edge of the blade. A tangent line drawn at any point along this curve, can be measured relative to a cylindrical surface, coaxial with the turbine runner rotation axis, which intersects the point. The slant angle is measured between the tangent line, and a vector lying on the cylindrical surface, perpendicular to the leading edge and coincident with the leading edge intersection point.)

Fish mortality is a function of the normal component w_{N} of the strike velocity at impact. Therefore, reducing the normal component w_{N} of the strike velocity at impact results in reduced fish mortality. Accordingly, fish mortality is reduced relative to a blunt blade at leading edge locations having a slant angle θ other than 90 degrees.

In some embodiments, leading edge 126 at a location can be slanted at an angle e of about 25 to about 45 degrees. In some embodiments, leading edge 126 at a location can be slanted at an angle 0 of about 30 degrees.

In some embodiments, leading edge 126 can be slanted at tip 124. As mentioned, strike speed increases from root 122 of blade 120 to tip 124 of blade 120, such that tip 124 of blade 120 has the greatest strike speed. Accordingly, providing leading edge 126 with a slant angle θ at tip 124 of blade 122 can reduce mortality where fish 300 would otherwise be more likely to experience a fatal impact. Providing a slanted leading edge 126 at tip 124 can also, for example, help to prevent build-up or accumulation of debris at tip 124.

In some embodiments, leading edge 126 can be slanted at a location between root 122 and tip 124. For the same reasons discussed above with respect to providing leading edge 126 with a slant angle at tip 124, providing leading edge 126 with a slant angle θ in a region between root 122 and tip 124 can reduce mortality where fish 300 may be relatively likely to experience a fatal impact.

In some embodiments, for example, as shown in FIG. 4, slant angle θ at tip 124 of blade 922 can be smaller than slant angle θ at root 120 and/or a location between root 122 and tip 124.

In some embodiments, leading edge 126 can be slanted at root 122. The slant angle of leading edge 126 of blade 120 at root 122 can be, for example, about 10 degrees to about 90 degrees, such as about 25 to about 45 degrees. In addition to improving survival of fish 300 impacting blade 120 at root 122, providing a slanted leading edge 126 at root 122 can also, for example, help to prevent build-up or accumulation of debris where root 122 of blade 120 meets hub 110.

In some embodiments, for example, as shown in FIG. 4, leading edge 126 of blade 120 can be slanted such that leading edge 126 is arc-shaped. In other embodiments, leading edge 126 can have a C-shape, a semi-circular shape, a parabolic shape, a conic shape, a saddle shape, or some other shape.

In some embodiments, for example, as shown in FIG. 4, leading edge 126 of blade 120 can curve toward trailing edge 128 of blade 120 near hub 110 such that leading edge 126 has a concave shape. This can allow, for example, smaller angles to be achieved at tip 124 while minimizing a cantilevered tip.

In some embodiments, leading edge 126 of blade 120 at root 122 can be slanted at a first angle θ, and leading edge 126 of blade 120 at tip 124 can be slanted at the same angle θ.

In some embodiments, root 122 of leading edge 126 of blade 120 is positioned along a radial axis 160 of runner 100, and tip 124 of leading edge 126 extends beyond radial axis 160 in circumferential direction 170. Thus, leading edge 126 of blade 120 can be cantilevered.

As tip 124 at leading edge 126 extends farther beyond radial axis 160 in circumferential direction 170, a smaller angle can be achieved. This can result in a lower normal component of strike velocity w_{N} at impact. However, as the angle continues to decrease, the structural stiffness of the blade may also decrease. This can result in increased manufacturing costs to maintain minimum structural stiffness requirements for the blade. Structural stiffness can be required, for example, to retain tip 124 of blade 120 in the tight tolerances of housing of a turbine.

In some embodiments, root 122 of leading edge 126 of blade 120 and tip 124 of leading edge 126 of blade 120 can both be positioned along radial axis 160.

As shown, for example, in FIG. 6, blade 120 of runner 100 can have a leading edge 126 that is arc-shaped when viewed along an axis that is perpendicular to shaft axis 150 (i.e., from a side of runner 100). For example, as shown in FIG. 6, when blade 120 is viewed from a side of runner 100, a leading edge 126 of blade 120 (from root 122 to tip 124) can curve away from an upstream end of runner 100 and then back toward an upstream end of runner 100.

In some embodiments, the cross section at the root can have substantially larger thickness near the leading edge, than any other cross section taken through the blade at any other radius. Its size and location can be such that the surface of the blade intersects with the hub with an obtuse angle all around the leading edge. This is important in order to allow uniform pressure distribution on the suction surface (i.e. downstream surface) of the blade. If instead the blade surface on the downstream side near the leading edge intersects with the spherical hub at an angle close to perpendicular, or an acute angle, then it is possible that a localized region of low pressure will be formed near the intersection of the blade surface and the spherical hub at this location, causing an unwanted reduction in the margin against cavitation.

In some embodiments, for example as shown in FIGS. 4 and 6, blade 120 of runner 100 can have a leading edge 126 that is arc-shaped when viewed along shaft axis 150 and when viewed along an axis that is perpendicular to shaft axis 150 (i.e., from a side of runner 100). However, in some embodiments, leading edge 126 may be arc-shaped only when viewed along shaft axis 150 or only when viewed along an axis that is perpendicular to shaft axis 150.

As shown, for example, in FIG. 6, blade 120 of runner 100 can have a leading edge 126 that is bowed. That is, the stacking line along the leading edge of the blade may have a nonzero angle relative to a radial line at the intersection with the end walls. In some embodiments, the blade may have a leading edge with negative bow, meaning the dihedral angle between the blade suction surface and the end walls is acute. In some embodiments, the blade may have a leading edge with positive bow, meaning the dihedral angle between the blade pressure surface and the end walls is acute. In some embodiments, the dihedral angle between the blade pressure wall and the hub may be different than the dihedral angle between the blade pressure wall and the housing. In some examples, leading edge 126 has a bow of about between −25 degrees-(90 to 75) degrees at the hub, and −15 degrees-(90 to 75) degrees at the tip. Blade may have various stagger angles, wherein the stagger angle refers to an angle between a chord line of a blade and the axial flow direction.

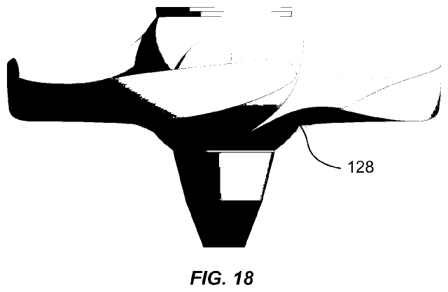

In some embodiments, for example, as shown in FIG. 6 and FIG. 18, trailing edge 128 can have an S-shape. A first portion 133 of the trailing edge can be concave, and a second portion 135 of the trailing edge (e.g., a portion of the trailing edge located farther from the hub than the first portion) can be convex. The can, for example, contribute to a desirable distribution of pressure over blade 120, and can assist in creating desirable distribution of fluid velocity leaving the runner and entering the draft tube or diffuser.

In some embodiments, for example as shown in FIG. 6, the trailing edge 128 can have an arc shape similar to the leading edge, when viewed along the shaft axis. This allows the surface area of the blade to be maximized, which may be important to achieve cavitation-free operation. A fish-safe runner may utilize fewer blades compared to a conventional design. For example, a conventional Kaplan turbine operating at 10 meters of head and positioned 3 meters above tailwater (i.e. drawing 3 meters of suction) may utilize 5 blades. A fish-safe runner with thick blades can be designed to replace the conventional runner with no changes to the conventional water passageway, but the fish-safe runner might benefit from a reduction in quantity of blades, such as to 4 blades, to allow the same flow rate and power output as the conventional runner. It may be necessary for each of the remaining blades to have a larger surface area than a conventional runner, to achieve similar pressure distribution. In order to achieve the necessary surface area, the trailing edge may intersect with the discharge ring surface and with the hub at steep angles. In some embodiments, the trailing edge intersects the discharge ring with an included angle between 5 degrees and 110 degrees, such as between 10 degrees and 45 degrees.

A cross section of blade 120 can be taken at root 122, at tip 124, or at a location between root 122 and tip 124. Each cross section can have a chord length L_{C} measured in a straight line from the leading edge 126 to the trailing edge 128. In some embodiments the chord length L_{C} at tip 124 is longer than the chord length L_{C} at root 122. For example, in some embodiments, the chord length L_{C} at tip 124 is approximately 1.6× to approximately 2.5× longer than the chord length L_{C} at root 122.

In some embodiments, the ratio of the chord length L_{C} at tip 124 to runner diameter D_{R} (i.e., L_{C,t}/D_{R}) can be less than about 0.9.

By providing a slanted leading edge 126, the orthogonal component of strike speed is effectively reduced, allowing runner 100 to rotate at a higher speed to improve power specific speed and economic competitiveness of runner 100 while maintaining safe fish passage. In some embodiments, runner 100 is configured to rotate such that an orthogonal component of strike speed is about 7 m/s or less in order to allow for safe fish passage (e.g., for safe passage of salmonids). In some embodiments, runner 100 is configured to rotate such that an orthogonal component of strike speed is about 11 m/s or less in order to allow for safe fish passage (e.g., for safe passage of eels). In some embodiments, even higher orthogonal strike speeds, of up to about 20 m/s, with very high survival rates of aquatic organisms, such as survival rates exceeding 98%. In some embodiments, the runner has tangential speed at the tip of up to 20-40 m/s while still achieving very high survival rates of aquatic organisms.

Runner 100 and/or blades 120 can be made of any suitable material and can be formed by any suitable process. In some embodiments, runner 100 and/or blades 120 are made of molded carbon/fiberglass and resin. In such embodiments, blade 120 can include a core composed of a lightweight foam. In some embodiments, runner 100 is composed of metal, such as bronze, stainless steel, or the like, and can be formed by castings, including hollow castings, that are machined to the final shape. In some embodiments, runner 100 and/or blades 120 are hollow. In some embodiments, runner 100 is composed of composites and is produced via conventional methods of composite construction. For example, runner 100 can have a sandwich composite construction or can include a shear web inside a structure, or can be made as a monocoque construction with thick walls. In some embodiments, runner 100 is composed of an elastomer or polymer, with reinforcements either locally or distributed throughout its interior.

Blade 120 can have a hybrid construction. In some embodiments, leading edge 126 of blade 120 is armored. Leading edge 126 can include a coating. Leading edge 126 can be metallic. In some embodiments, blade tips 124 are molded with a thick layer of ablative material such that blades tips 124 can wear into the inner diameter of a housing of a turbine (shown, e.g., in FIGS. 14-16). One or more of blades 120 may include an anti-cavitation lip. Anti-cavitation lip may include a lip extending from a blade tip 124 along at least a portion of length of blade tip 124 between leading edge 126 and trailing edge 128. Anti-cavitation lip may be in the form of a flat plate. The ant-cavitation lip may help to control flows around the tip of the blades.

In some embodiments, a diameter D_{R} of runner 100 can be at least about 1.5 meters. In some embodiments, a diameter D_{R} of runner 100 can range from about 1.5 meters to about 7 meters, such as about 2 meters to about 5 meters. Diameter may correspond to a spherical diameter measured from an outer radius of the turbine blades.

The ratio of axial length L_{R} of runner 100 to diameter D_{R} of runner 100 at a downstream side of runner 100 can be less than approximately 0.55, or can be approximately 0.25 to approximately 0.55. Runner 100 may have an axial tip length Lₜ defined as the distance between tip 124 of leading edge 126 and tip 124 of trailing edge 128. In some examples, the size of the housing may be determined by the axial tip length Lₜ.

FIG. 20 shows that a blade 1920 center of pressure 1930 and center of mass 1940 may be offset. For example, center of pressure 1930 may be located closer to a trailing edge 1928 of blade 1920 than center of mass 1940. Center of pressure 1930 may also be closer to a top 1924 of blade 1920 than blade center of mass 1940. In some examples, a trailing edge 1928 overhangs, or extends downstream of the spherical or cylindrical portion of the turbine housing. The blade center of mass 1940 may be near a blade pivot axis 1950. The blade material may be one variable that affects the location of blade 1920 center of pressure 1930 and center of mass 1940. Other variables may be the axial tip length, leading edge thickness, and trailing edge overhang.

A blade with trailing edge overhang may have a larger blade surface area relative to a blade with no trailing edge overhang. However, blades with a trailing edge overhang may distribute more of the weight of the blade downstream of the pivot axis compared to blades without trailing edge overhang, putting stress on the pivot. To mitigate downstream weight distribution issues, the blade may have forward lean and a thick leading edge to help optimize distribution of mass

FIG. 20 illustrates one example of components for actuating blade 1920. However, other components and arrangements for actuation of a blade may be used, as understood by one skilled in the art. Actuation mechanisms may include an oil-filled hub, oil-free hub, or direction actuation of each blade.

As mentioned, in some embodiments, runner 100 is integrated into turbine 200 (shown, for example, in FIGS. 14-16). In FIGS. 14-16, shaft axis 150 is vertical with respect to ground. However, in other embodiments, shaft axis 150 can be horizontal with respect to ground or can be at an angle between horizontal and vertical with respect to ground. In some embodiments, the runner drives a shaft upstream of the runner. In other embodiments, the runner drives a shaft downstream of the runner.

In some embodiments, turbine 200 can include inlet and outlet elements commonly known. Inlet elements can include, for example, a spiral or a semi-spiral. In some embodiments, an inlet of turbine 200 is intended to be connected to the discharge of a pressurized pipe, penstock, or scroll case. Outlet elements can include, for example, a draft tube. The draft tube can have changes in cross sectional area appropriate to recover velocity head. The draft tube can be straight, or have bends, as is appropriate given characteristics of the hydropower plant.

In operation, water can flow into turbine 200, pass through a stage of guide vanes (which can be fixed in pitch, or adjustable, as required by the application) if guide vanes are present, pass through runner 100, and exit into a diffuser or draft tube, and from there into to a tailwater or an outlet pipe which communicates the discharged water to a tailwater.

In some embodiments, turbine 200 operates at a head of at least 1 meter. In some embodiments, turbine 200 operates at a head of at least 10 meters. In some embodiments, turbine 200 operates at a head of at least 20 meters. In some embodiments, turbine 200 operates at a head of at least 30 meters. In some embodiments, turbine 200 operates at a head of at least 40 meters.

In some embodiments, runner 100 can be incorporated into turbine 200, and turbine 200 can be part of a hydroelectric installation including several turbines.

In some embodiments, runner 100 is retrofit into an existing turbine or hydroelectric installation. In a retrofit, it is often important to minimize changes to existing civil works and electrical infrastructure. For example, a retrofit may have strict constraints to utilize an existing generator at a fixed shaft speed, with runner installed at a pre-determined elevation with respect to tailwater elevation, operating with an existing intake chamber, runner discharge ring, and draft tube, all of which tightly constrain the design envelope in which a fish-safe runner can be created.

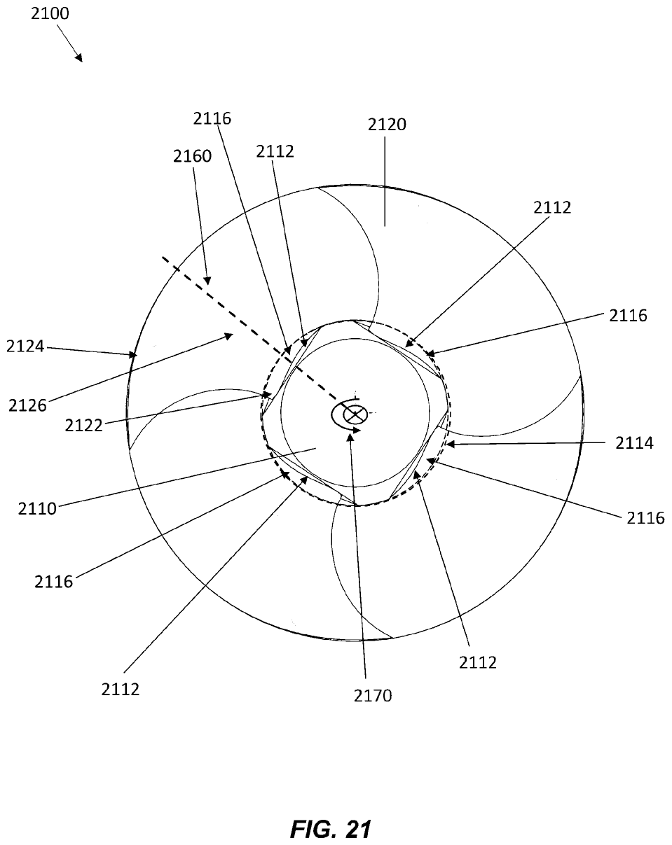

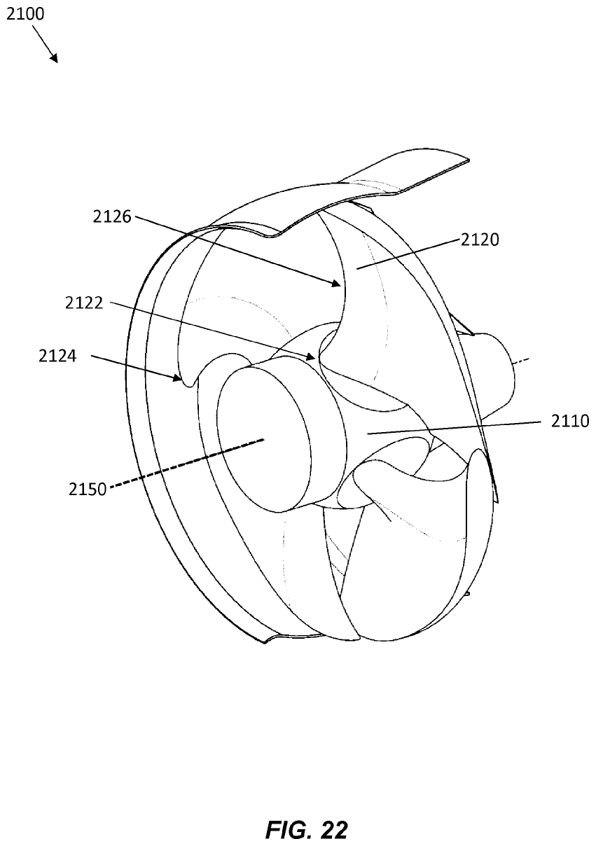

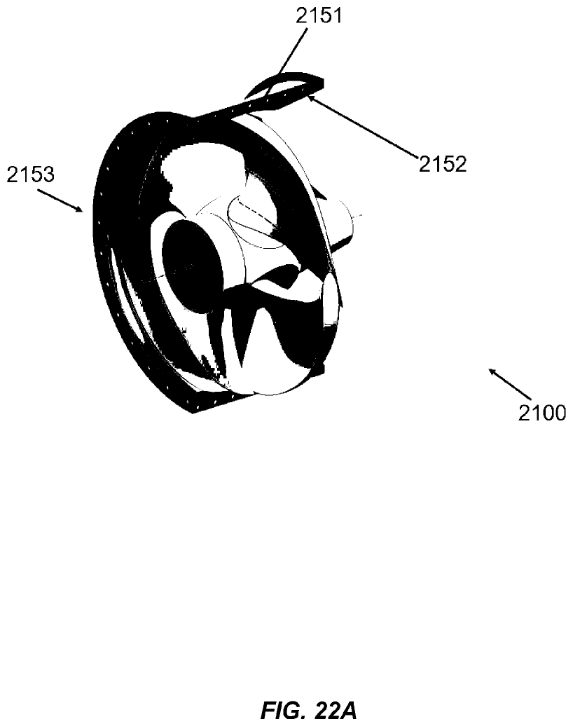

Referring now to FIGS. 21-22, a runner 2100 for a hydraulic turbine is illustrated. Runner 2100 may have features as described above with respect to runner 100. For example, runner 2100 may have blades pivotably coupled to hub.

Runner 2100 of FIGS. 21-22 differs in having a non-circular or non-spherical hub 2110. Runner 2100 may have a pseudo-polygonal hub 2110. Hub 2110 may have a generally spherical shape, but with a plurality of faces 2112. Faces 2112 may not correspond to the spherical shape of hub 2110. In some examples, the plurality of faces may have a curved or convex shape. Faces 2112 may have a spherical shape with a larger radius of curvature relative to the other portion of the hub 2110. In other words, the plurality of faces 2112 may have less curvature than portions of the hub 2110 other than the faces 2112. In some examples, the plurality of faces 2112 are generally flat or planar. Each face 2112 may have a circular area or perimeter. As illustrated in FIG. 21, hub 2110 may have a cube shape with rounded portions. Hub 2110 may have four or more faces 2112, and each face 2112 may have a circular shape. The faces 2112 may be radially spaced around a longitudinal axis of hub 2110. The faces 2112 may be configured to be coupled to a blade 2120. In some examples, a portion of blade 2120 coupled to face 2112 may have a different shape or size relative to face 2112. According to some examples, each face 2112 may be flat or planar when the face 2112 is viewed at an angle perpendicular to the face 2112. In some examples, the rest of the hub 2110, other than the faces 2112, may be rounded. In some examples, hub 2110 may have four blades 2120, and a root 2122 of each blade 2120 may be coupled to hub 2110 at the face 2112. Hub may have a face 2112 for each blade of the runner. Some examples may include more than four faces 2112 and more than four blades 2120, such as, for example, between six and ten faces and between six and ten blades 2120. Pseudo-polygonal hub 2110 may create an increased cross-sectional flow area compared to hubs with other shapes. For example, a perimeter of a hypothetical spherical hub 2114 is illustrated in FIG. 21. As can be seen in this example, spaces 2116 may exist between hypothetical spherical hub 2114 and the perimeter of the pseudo-polygonal hub 2110. These spaces 2116 may provide additional flow area, and increasing the cross-sectional flow area may reduce the average flow velocity for a given power output.

According to some embodiments, as illustrated in FIG. 21, a leading edge 2126 of one or more blades 2120 may have a forward lean in a direction of rotation. For example, root 2122 may be positioned at a radial axis 2160 of runner 2100, and tip 2124 of leading edge 2126 may extend beyond radial axis 2160 in circumferential direction 2170. The leading edge 2126 may have a concave shape, as illustrated in FIGS. 21-22.

The turbine may have a discharge ring 2153, as illustrated in FIG. 22A. The discharge ring 2153 may be a split discharge ring with two or more segments that connect along one or more planes that are perpendicular to the shaft axis 150. The two or more segments may also connect along one or more planes that are parallel to the shaft axis 150. In some examples, two segments connect along a single plane. In some embodiments, three or more wedge-shaped segments connect along multiple planes. The segments may connect via bolt holes 2152, among other fastening methods. As illustrated in FIG. 22A, each segment of the discharge ring 2153 may have a split surface for abutting and connecting the portion to one or more other portions to form the discharge ring 2153.

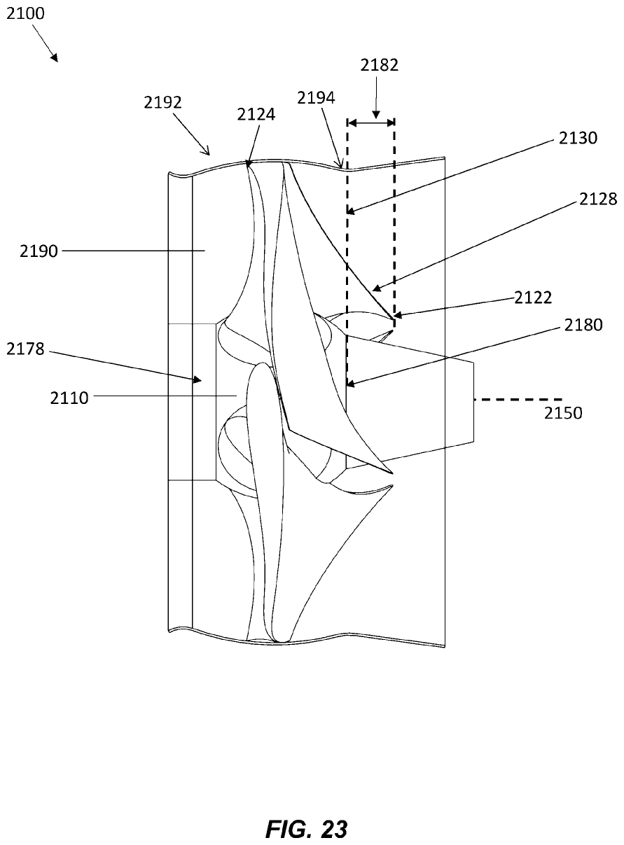

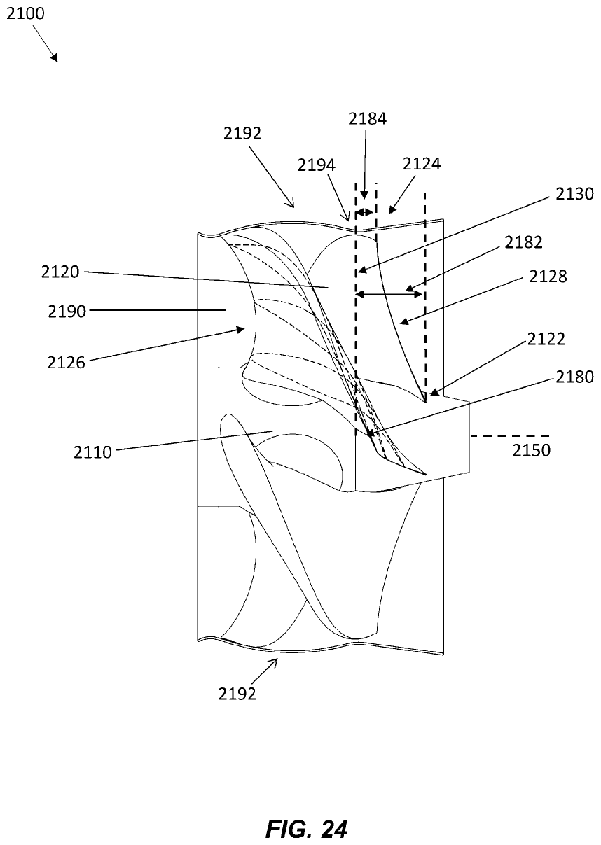

FIGS. 23-24 illustrate embodiments where runner 2100 has a trailing edge 2128 that extends rearward of a downstream end 2180 of hub 2110. In some examples, the leading edge 2126 may not extend forward of a discharge ring or dome portion 2192 of housing 2190, while the trailing edge may extend rearward of dome portion 2192. Hub 2210 may have an upstream end 2178 and a downstream end 2180. As shown in FIG. 23, downstream end 2180 may be the surface of hub 2110 that is furthest downstream in longitudinal direction 2150. According to some examples, root 2122 of trailing edge 2128 may extend rearward of downstream end 2180 in longitudinal direction 2150. The distance the root 2122 extends rearward of downstream end 2180 in longitudinal direction 2150 may define a trailing edge overhang 2182.

As illustrated in FIG. 24, the entire trailing edge 2128 may extend rearward of downstream end 2180 of hub 2110. In these examples, there may be a trailing edge tip overhang 2184 in addition to or alternative to a trailing edge root overhang 2182. In some embodiments, trailing edge root overhang 2182 may be greater than trailing edge tip overhang 2184. In some examples, root 2122 of trailing edge 2128 may extend rearward, or further downstream, relative to the remainder of blade 2120.

In operation, as illustrated in FIGS. 23-24, runner 2100 may be enclosed by a housing 2190 of a turbine. Housing 2190 may have discharge ring or dome portion 2192. In some examples, as illustrated in FIG. 24, dome portion 2192 may surround a portion of runner 2100. According to some examples, a rear of the dome portion 2192 may radially align with downstream end 2180 of hub 2110, i.e., along axis 2130.

In some embodiments, trailing edge 2128 of blade 2120 may extend downstream of dome portion 2192. In some embodiments, trailing edge root overhang 2182 and trailing edge tip overhang 2184 may be measured relative to the rear end 2194 of dome portion 2192, rather than being measured relative to downstream end 2180. As illustrated in FIG. 23, in some embodiments, root 2122 of trailing edge 2128 may extend rearward of dome portion 2192 and tip 2124 of trailing edge 2128 may not extend rearward of dome portion 2192. In some examples, tip 2124 may be positioned forward relative to the rear of dome portion 2192. In other embodiments, as illustrated in FIG. 24, both tip 2124 and root 2122 of trailing edge may overhang dome portion 2192, or extend rearward of dome portion 2192. In some examples, entire trailing edge 2128 may be positioned rearward of dome portion 2192.

Runners 2100 with trailing edge root overhang 2182 may have similar benefits whether root overhang 2182 is measured from rear of hub 2110 or from the rear of dome portion 2192. For example, trailing edge root overhang 2182 increases the chord length relative to blades without an overhang, thus increasing the surface area of blade 2120. This increased surface area may be achieved without increasing a spherical outer diameter of runner 2100. Extending trailing edge 2128 downstream also allows for longer chord lengths which may reduce suction pressures and may minimize cavitation.

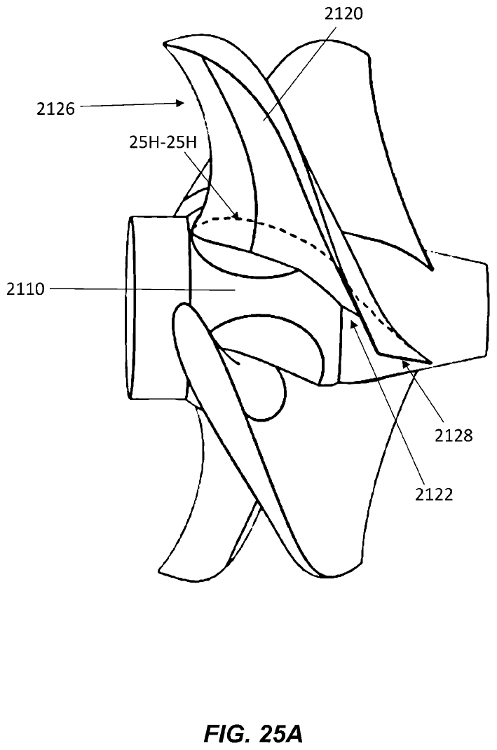

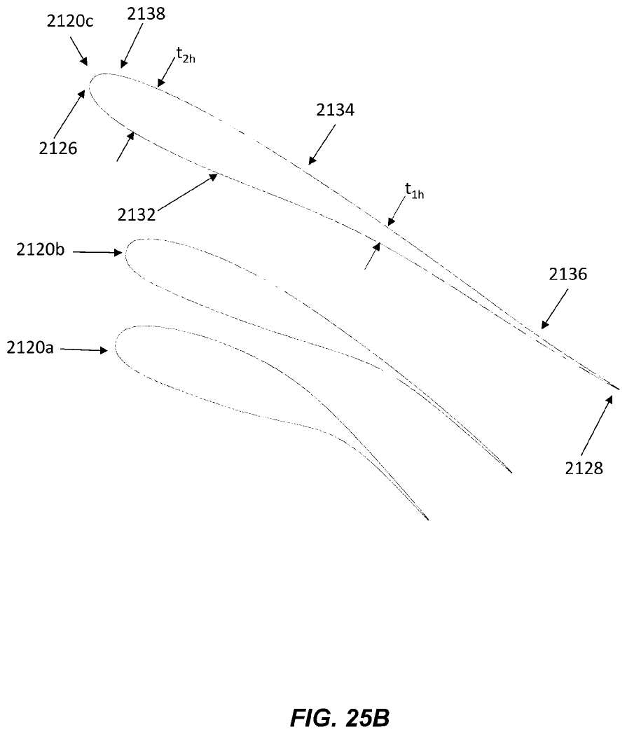

According to the illustrative embodiments of FIGS. 24-25B, a cross section through blade 2120 may be taken at line 25H-25H. Cross section at line 25H-25H may correspond to a cross section of blade 2120 taken at root 2122. The cross sectional shapes of the blade as taken at a root, midspan, and tip are shown for example in FIG. 25B.

As illustrated in FIG. 25B, cross section of blade 2120 at line 25H-25H may have a varying thickness. A thickness taken near trailing edge 2128 may be smaller than a thickness at leading edge 2126. A first root thickness t₁ₕ may be located closer to the trailing edge 2128 than a second root thickness t₂ₕ, and the first root thickness t₁ₕ may be smaller than the second root thickness t₂ₕ. The first root thickness t₁ₕ as a proportion of chord length (tₕ/chord) may be between approximately 0.03-0.1 at the root, between approximately 0.01-0.05 at the midspan or midline of blade 2120, and between approximately 0.01-0.05 at the tip. The second root thickness t₁ₕ may be between approximately 0.1-0.2 at the root, between 0.08-0.16 at the midspan or midline of the blade 2120, and between approximately 0.05-0.11 at the tip.

According to some examples, the surface curvature of cross section at 25H-25H may have a first shape 2136 and a second shape 2138. The first shape 2136 may be rearward relative to the second shape 2138, and the first and second shape 2136, 2138 may be defined by surface 2132 or surface 2134. The first shape 2138 may be positioned closer to trailing edge 2128 relative to the second shape 2136, and the second shape 2138 may be positioned closer to leading edge 2126. In some embodiments, a minimum thickness of the second shape 2138 may be greater than a maximum thickness of the first shape 2136. In other examples, a maximum thickness of the second shape 2138 may be greater than the maximum thickness of the first shape 2136.

In some embodiments, the first shape 2136 may be convex and the second shape may be concave. In some examples, leading edge 2126 may have a concave shape, which may correspond to a thick leading edge 2126 of blade 2120. In some examples, the leading edge 2126 may have an arc-shape when viewed along an axis that is perpendicular to a shaft axis of runner 2100. Thick leading edge 2126 may promote fish safety. Conversely, trailing edge 2128 may be narrow relative to leading edge 2126. In some examples trailing edge 2128 may be tapered. A narrow trailing edge 2128 may improve efficiency of runner 2100 relative to a runner without a narrow trailing edge. In some examples, the thickness distribution at the intersection of root 2122 with hub 2110 may be steep.

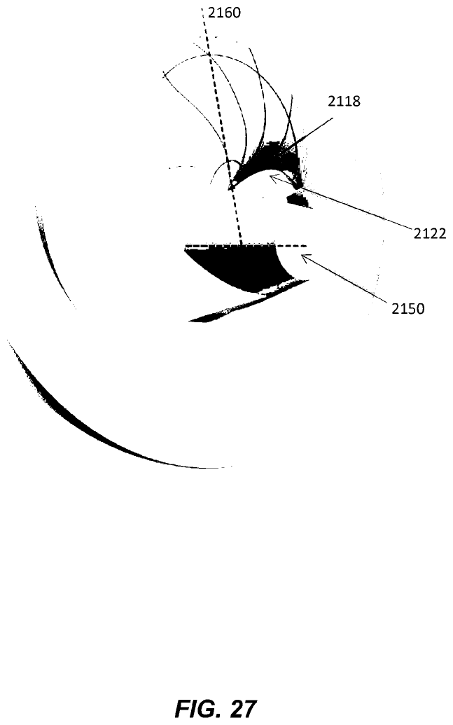

In some examples, blades 2120 with root 2122 extending further downstream than the rest of trailing edge 2128, and having the thickness distribution with a steep positive slope at the intersection of root 2122 with hub 2110 may result in improved pressure distribution relative to conventional blades. This may be illustrated, for example, in FIG. 27, which shows a downstream surface 2118 near root 2122 curves away from radial line 2160. For example, the pressure may be more evenly distributed across the surface of blade 2120 relative to conventional blades. An optimal pressure distribution may help to reduce barotrauma of entrained fish. Barotrauma refers to injuries caused by changes in barometric or water pressure. An optimal pressure distribution may reduce other injuries resulting from locally severe or uneven pressure distributions.

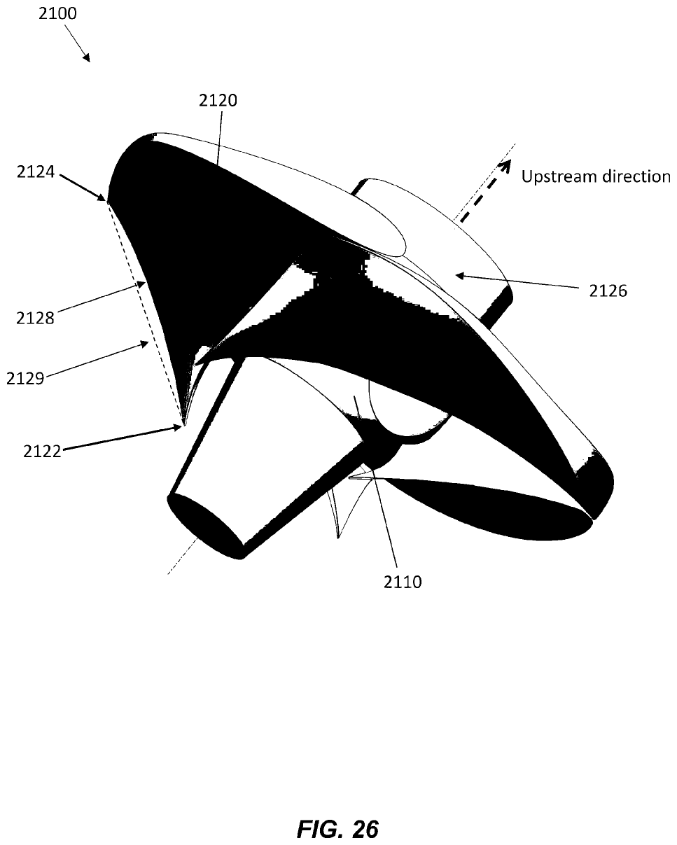

In the illustrative examples of FIGS. 26-27, runner 2100 may include a blade 2120 with a trailing edge 2128 that is bowed or curved in an upstream direction. In other words, a portion of trailing edge 2128 between tip 2124 and root 2122 may be longitudinally positioned upstream relative to trailing edge 2128 at tip 2124 and root 2122. An imaginary line 2129 may be drawn from tip 2124 to root 2122 of trailing edge 2128. Trailing edge 2128 may be positioned upstream relative to imaginary line 2129 except for tip 2124 and root 2122. In some examples, a portion of trailing edge 2128 may be positioned in an upstream direction relative to imaginary line 2129. According to some embodiments, the entire trailing edge 2128 may be positioned upstream relative to the imaginary line 2129 except for tip 2124 and root 2122.

Trailing edge 2128 bowing in the upstream direction helps to mitigate cavitation risk on a surface downstream of leading edge 2126 at tip 2124 when blades 2120 are pitched towards a closed or nearly closed position. In other words, when blades 2120 are pitched towards a closed position, the upstream bow in trailing edge 2128 may create clearance between adjacent blades 2120, mitigating risk of cavitation. The upstream bow in trailing edge 2128 may mitigate high velocities and low pressures near the trailing edge 2128.

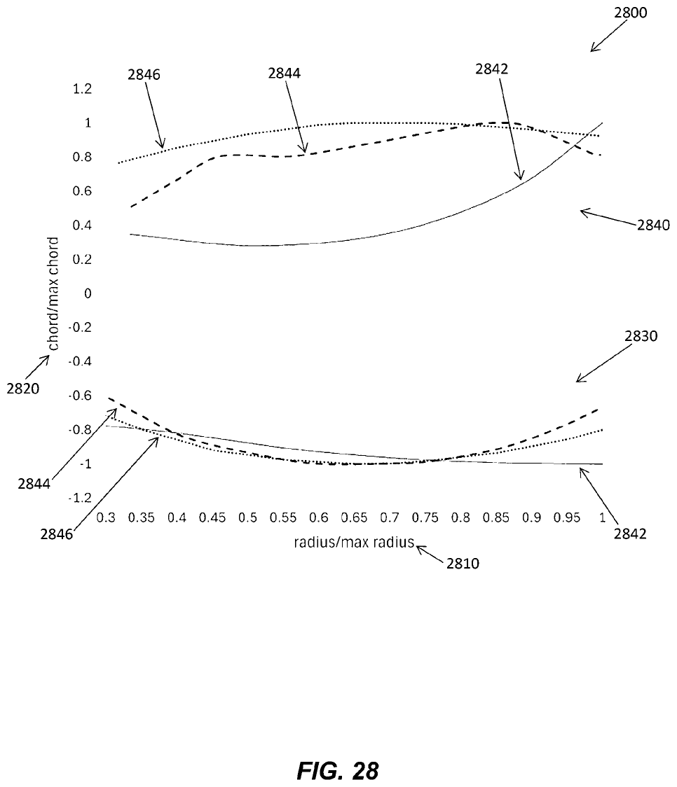

FIG. 28 is a graph 2800 showing a comparison of normalized chord distribution of a blade for the present disclosure 2842, compared to conventional Kaplan blades 2844, 2846. An x-axis 2810 is defined as a ratio of the radius of a blade to the maximum radius of the blade (radius/max radius). The ratio is 1 at the tip, because the maximum radius is at the tip of the blade. The y-axis represents a ratio of chord length to a maximum chord length (chord/max chord). The maximum chord length is 1 at the tip of the blade, because the tip for the turbine of the present disclosure 2842 has a maximum chord length. There are two sets lines for each blade, upper set of lines 2840 correspond to a leading edge of each blade, or an upstream region, and lower set of lines 2830 correspond to a trailing edge or downstream region of each blade. This graph illustrates, among other features, that the turbine blade of the present disclosure has a forward lean or tip slant as opposed to the conventional blades that curls back towards the longitudinal axis of the turbine.

It is to be appreciated that the Detailed Description section, and not the Summary and Abstract sections, is intended to be used to interpret the claims. The Summary and Abstract sections may set forth one or more but not all exemplary embodiments of the present invention(s) as contemplated by the inventors, and thus, are not intended to limit the present invention(s) and the appended claims in any way.

The present invention(s) have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention(s) that others can, by applying knowledge within the skill of the art, readily modify and/or adapt for various applications such specific embodiments, without undue experimentation, and without departing from the general concept of the present invention(s). Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance herein.

The breadth and scope of the present invention(s) should not be limited by any of the above-described exemplary embodiments, but should be defined only in accordance with the following claims and their equivalents.

Additional embodiments of the invention may be further exemplified by the following numbered clauses

1. A runner for a hydraulic turbine, comprising: a hub; and a plurality of pivotable blades extending from the hub, each pivotable blade of the plurality of pivotable blades comprising: a root located at the hub, a tip opposite the root, and a leading edge opposite a trailing edge, wherein each pivotable blade of the plurality of pivotable blades is pivotable relative to the hub about a respective pivot axis, and wherein for at least one blade, the leading edge at the root is positioned along a radial axis of the runner and the leading edge at the tip is cantilevered beyond the radial axis in a circumferential direction of the runner; wherein a leading edge thickness is greater than a trailing edge thickness.

2 The runner of clause 1, wherein trailing edge is arranged downstream of a downstream end of the hub for at least one pivotable blade of the plurality of pivotable blades.

3 The runner of clause 2, wherein the tip of the trailing edge is arranged downstream of the downstream end of the hub.

4 The runner of clause 2, wherein the root of the trailing edge extends further downstream than a remainder of the trailing edge.

5 The runner of any of clauses 1 to 4, wherein at least one pivotable blade of the plurality of pivotable blades has a cross section at the root with a surface curvature having a first shape and a second shape, optionally wherein the first shape is concave and the second shape is convex.

6. The runner of clause 5, wherein a maximum root thickness of the second shape is greater than a maximum root thickness of the first shape and the first shape is positioned closer to the trailing edge than the second shape.

7 The runner of any of clauses 1 to 6, wherein the hub comprises a plurality of faces that are planar.

8. The runner of clause 7, wherein a face of the plurality of faces has a circular shape.

9. The runner of clause 7 or 8, wherein each face of the plurality of faces is coupled to a root of a pivotable blade of the plurality of pivotable blades.

10. The runner of any of clauses 1 to 9, wherein the trailing edge of a pivotable blade of the plurality of pivotable blades bows in an upstream direction between the tip and root of the pivotable blade.

11. The runner of any of clauses 1 to 10, wherein a thickness of the leading edge of a pivotable blade of the plurality of pivotable blades is greater than about 100 mm.

12. A runner for a hydraulic turbine, comprising: a hub; and a plurality of pivotable blades extending from the hub, each pivotable blade of the plurality of pivotable blades comprising: a root located at the hub, a tip opposite the root, and a leading edge opposite a trailing edge, wherein each pivotable blade of the plurality of pivotable blades is pivotable relative to the hub about a respective pivot axis, and wherein for at least one blade, the leading edge is arc-shaped when viewed along an axis that is perpendicular to a shaft axis of the runner; wherein at least one pivotable blade of the plurality of pivotable blades has a cross section at the hub with a surface having a first shape and a second shape, wherein the first shape is concave and the second shape is convex.

13. The runner of clause 12, wherein the hub is cubically shaped with rounded edges and one or more faces having circular shapes, the faces being radially spaced around a longitudinal axis of the hub.

14. The runner of clause 12 or 13, wherein the root of the trailing edge extends further downstream than a remainder of the trailing edge.

15. A turbine, comprising: a housing defining an inlet and an outlet for a flow of liquid; and a runner positioned within the housing, the runner comprising: a hub; and a plurality of pivotable blades extending from the hub, each pivotable blade of the plurality of pivotable blades comprising: a root located at the hub; a tip opposite the root; and a leading edge opposite a trailing edge, wherein each pivotable blade of the plurality of pivotable blades is pivotable relative to the hub about a respective pivot axis, and wherein for at least one blade, the leading edge at the root is positioned along a radial axis of the runner and the leading edge at the tip is cantilevered beyond the radial axis in a circumferential direction of the runner; wherein at least one pivotable blade of the plurality of pivotable blades has a cross section at the hub with a surface having a first shape located closer to the leading edge than a second shape, wherein the first shape is concave and the second shape is convex, and a thickness of the leading edge is greater than a thickness of the trailing edge.

16. The turbine of clause 15, wherein the hub is cubically shaped with rounded edges and one or more faces.

17. The turbine of clause 16, wherein each of the one or more faces has a circular shape.

18. The turbine of any of clauses 15 or 17, wherein the faces are radially spaced around a longitudinal axis of the hub.

19. The turbine of any of clauses 15 to 18, wherein the root of the trailing edge, the tip of the trailing edge, or both the root of the trailing edge and the tip of the trailing edge extend rearward of a downstream end of the hub.

20. The turbine of any of clauses 15 to 19, wherein the trailing edge of a pivotable blade of the plurality of pivotable blades bows in an upstream direction between the tip and the root.

What is claimed is:

1. A runner for a hydraulic turbine, comprising:
a hub; and
a plurality of pivotable blades extending from the hub, each pivotable blade of the plurality of pivotable blades comprising:
a root located at the hub,
a tip opposite the root, and
a leading edge,
wherein each pivotable blade of the plurality of pivotable blades is pivotable relative to the hub about a respective pivot axis,
wherein a ratio of a thickness of the leading edge T_{LE} to a diameter of the runner D_{R} is in a range of approximately 0.03 to approximately 0.35, and
wherein for at least one blade, the leading edge at the root is positioned along a radial axis of the runner and the leading edge at the tip is cantilevered beyond the radial axis in a circumferential direction of the runner.

2. The runner of claim 1, wherein a ratio of an axial length of the runner to a diameter of the runner is less than about 0.55.

3. The runner of claim 1, wherein a ratio of a chord length at the tip of each pivotable blade to the diameter of the runner is less than about 0.9.

4. The runner of claim 1, wherein each pivot axis is angled relative to a shaft axis of the runner at an angle between approximately 8 degrees and approximately 155 degrees.

5. The runner of claim 1, wherein an outer surface of the hub swept by the root of each pivotable blade during rotation of the blade from a maximum pitch to a minimum pitch is spherically shaped.

6. The runner of claim 1, wherein the root of each pivotable blade conforms to the shape of an outer surface of the hub during rotation of the pivotable blade from a maximum pitch to a minimum pitch,
wherein the tip of each pivotable blade has a generally spherical sweep shape over a pivot range of the pivotable blade from the maximum pitch to the minimum pitch.

7. The runner according to claim 1, wherein a thickness of the leading edge of each pivotable blade is between about 100 mm and about 700 mm.

8. The runner of claim 1, wherein a portion of the leading edge at the tip of each pivotable blade is slanted relative to a radial axis of the runner at an angle between approximately 20 degrees and approximately 90 degrees.

9. The runner of claim 1, wherein the leading edge of each pivotable blade is arc-shaped when viewed along an axis that is perpendicular to a shaft axis of the runner, and
wherein the leading edge of each pivotable blade when viewed along the axis that is perpendicular to the shaft axis of the runner curves away from an upstream end of the runner at the root and back toward an upstream end of runner toward the tip.

10. The runner of claim 1, wherein a radius of curvature of the one or more faces is larger than a radius of curvature of the rounded edges of the hub.

11. The runner of claim 1, wherein a first portion of the trailing edge is concave, a second portion of the trailing edge is convex, and the first portion of the trailing edge is located closer to the hub than the second portion of the trailing edge.

12. A turbine, comprising:
a housing defining an inlet and an outlet for a flow of liquid; and
a runner for a hydraulic turbine, comprising:
a hub; and
a plurality of pivotable blades extending from the hub, each pivotable blade of the plurality of pivotable blades comprising:
a root located at the hub,
a tip opposite the root, and
a leading edge opposite a trailing edge,
wherein each pivotable blade of the plurality of pivotable blades is pivotable relative to the hub about a respective pivot axis,
wherein a ratio of a thickness of the leading edge T_{LE} to a diameter of the runner D_{R} is in a range of approximately 0.03 to approximately 0.35, and
wherein for at least one blade, the leading edge at the root is positioned along a radial axis of the runner and the leading edge at the tip is cantilevered beyond the radial axis in a circumferential direction of the runner.

13. The turbine of claim 12, wherein the tip of each pivotable blade conforms to a shape of a discharge ring of the housing during rotation of the blade from a maximum pitch to a minimum pitch, and
wherein an inner surface of the discharge ring of the housing swept by the tip of each pivotable blade during rotation of the pivotable blade from the maximum pitch to the minimum pitch is spherically shaped.

14. The turbine of claim 12, wherein a discharge ring of the housing has removable segments that are configured to be removably assembled from either an exterior or from an interior of the turbine, and wherein the discharge ring of the housing is split.

15. The turbine of claim 12, wherein the root of the trailing edge extends further downstream than a remainder of the trailing edge.

16. A runner for a hydraulic turbine, comprising:
a hub; and
a plurality of pivotable blades extending from the hub, each pivotable blade of the plurality of pivotable blades comprising:
a root located at the hub,
a tip opposite the root, and
a leading edge opposite a trailing edge,
wherein each pivotable blade of the plurality of pivotable blades is pivotable relative to the hub about a respective pivot axis, and wherein for at least one blade, the leading edge at the root is positioned along a radial axis of the runner and the leading edge at the tip is cantilevered beyond the radial axis in a circumferential direction of the runner,
wherein, in a meridional section, the trailing edge at the root of the blade is located further downstream than the trailing edge at the tip of the blade.

17. The runner of claim 16, wherein trailing edge extends downstream of a downstream end of the hub for at least one pivotable blade of the plurality of pivotable blades.

18. The runner of claim 16, wherein at least one pivotable blade of the plurality of pivotable blades has a cross section at the root with a surface curvature having a first shape and a second shape, wherein the first shape is concave and the second shape is convex.

19. The runner of claim 16, wherein the hub comprises a plurality of faces that are planar, the faces being radially spaced around a longitudinal axis of the hub.

20. The runner of claim 16, wherein the trailing edge of a pivotable blade of the plurality of pivotable blades bows in an upstream direction between the tip and the root of the pivotable blade.
